(19) United States
(12) Patent Application Publication
(10) Pub. No.: US 2003/0047627 A1
(43) Pub. Date: Mar. 13, 2003

(54) Fuel injection valve

(76) Inventors: Hubert Stier, Asperg (DE); Guenther Hohl, Stuttgart (DE); Norbert Keim, Loechgau (DE)

Correspondence Address: KENYON & KENYON, ONE BROADWAY, NEW YORK, NY, 10004, US

(21) Appl. No.: 10/110,290

(22) PCT Filed: Aug. 9, 2001
(86) PCT No.: PCT/DE01/02951

(30) Foreign Application Priority Data
Aug. 10, 2000 (DE) 100 39 083.8

(51) Int. Cl. F02M 51/00

(52) U.S. Cl. 239/585.5; 239/585.4; 239/585.1

(57) ABSTRACT

A fuel injector (1) for fuel injection systems in internal combustion engines has a magnet coil (10), an armature (20) that is acted upon in a closing direction by a restoring spring (23), and a valve needle (3) that is non-positively engaged with armature (20) for actuating a valve closing body (4), which together with a valve seat surface (6) forms a sealing seat, armature (20) with an inlet-side armature surface (34) striking internal pole (13). A choke point (36) is provided on inlet-side armature surface (34), and is formed by an annular, stepped prominence (35) on inlet-side armature surface (34).

### BACKGROUND INFORMATION

The present invention relates to a fuel injector according to the definition of the species of the main claim.

German Patent Application 196 26 576 A1 describes a fuel injector having a choke-like narrowing in the area of the magnet armature. The fuel is fed in such a manner that it flows through the choke-like narrowing with a flow component directed away from the injection orifice. This causes an at least partially compensating counterforce to be exerted on the valve needle or on the armature which is non-positively connected to the valve needle.

The disadvantage of the fuel injector described in the above-cited document is particularly the complicated construction, which entails considerable effort in manufacturing the components.

Moreover, it is not possible to optimize the closing times in the fuel injector described above by targeted use of the fuel back pressure acting on the armature, so that the opening times of the fuel injector also need improvement, since the restoring spring must possess a strong closing force in order to seal the fuel injector against the pressure of the combustion chamber.

Known fuel injectors are provided with spiral flutes or swirl boreholes in the region of the metering point. The choking of the fuel flow in the area of these flutes or swirl boreholes results in a force component acting on the valve needle in the direction of closure. This may adversely affect the valve behavior.

### ADVANTAGES OF THE INVENTION

The fuel injector according to the present invention having the characterizing features of the main claim has the advantage over the related art due to the fact that on the one hand the hydraulic forces may be used to shorten the closing time of the fuel injector, since the choke point situated between the armature and the internal pole causes a small buildup of back pressure on the armature, and on the other, as a result of the hydraulic forces acting on the armature stop by damping, rebound behavior is improved during the opening operation.

Advantageous refinements of the fuel injector described in the main claim are possible through the measures indicated in the subordinate claims.

The prominence at the choke point advantageously has a wedge shape to prevent hydraulic adhesion of the armature to the stop.

It is also advantageous that the boreholes used for dechoking may be placed simply at the desired location in the armature.

In particular, dechoking may be performed particularly easily via the center cutaway in the armature, since the center cutaway only needs to be drilled with a slightly larger diameter when the armature is manufactured.

It is also advantageous if the prominence is formed on the armature stop surface of the internal pole, since in this way the shape of the armature does not need to be changed.

The provision of a shoulder on the outflow surface of the internal pole as a choke point is advantageous, since this variant of the embodiment is particularly easily manufactured.

### BRIEF DESCRIPTION OF THE DRAWING

Embodiments of the invention are illustrated in simplified form in the drawing and are explained in greater detail in the following description.

FIG. 1 shows a schematic section through an example of a fuel injector according to the related art;

FIG. 2 shows a schematic partial cutaway section through a first embodiment of a fuel injector according to the present invention, in the area II indicated in FIG. 1;

FIG. 3A shows a schematic sectional view of a second embodiment of a fuel injector according to the present invention having boreholes for dechoking;

FIG. 3B shows a schematic sectional view of a third and fourth embodiment of a fuel injector according to the present invention having boreholes for dechoking, and

FIG. 3C shows a schematic section of a fifth and a sixth embodiment of a fuel injector according to the present invention with stop dechoking.

### DESCRIPTION OF THE EXEMPLARY EMBODIMENTS

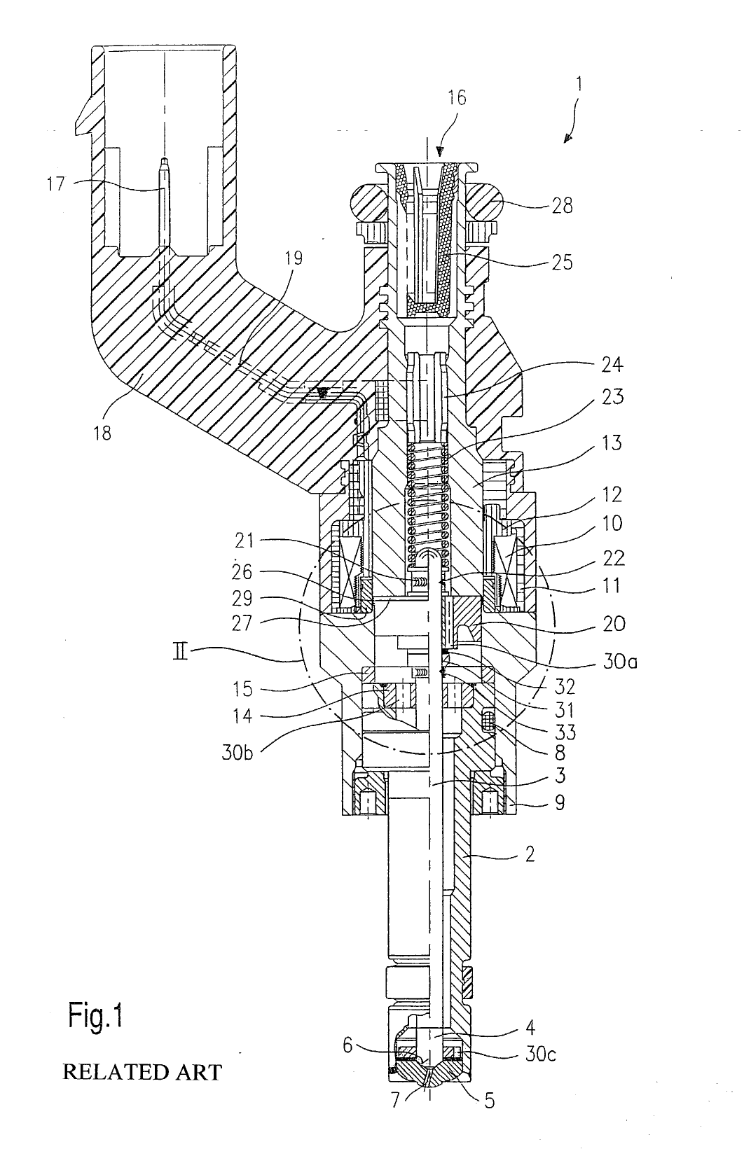

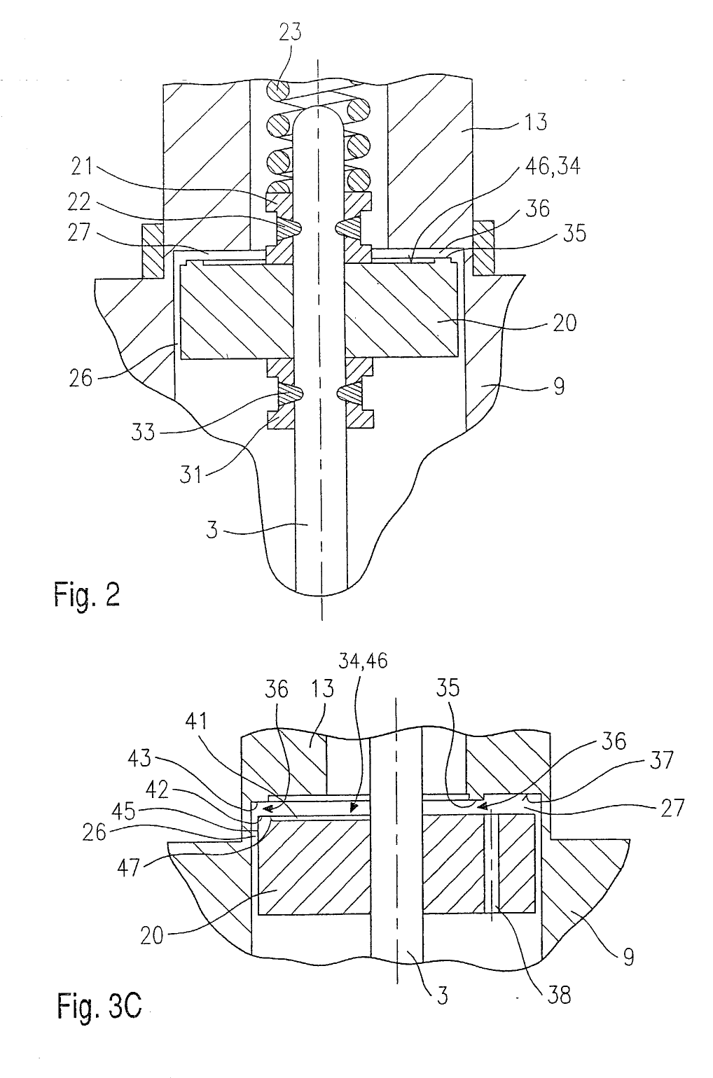

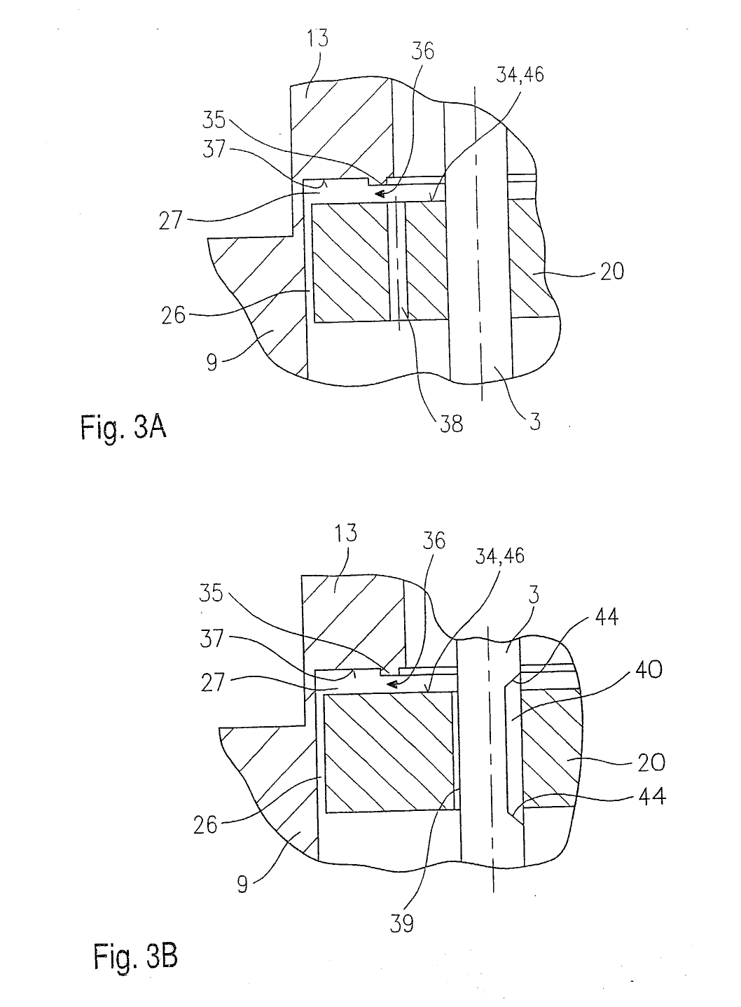

Before proceeding with a detailed description of the fuel injector 1 according to the present invention with reference to FIGS. 2 and 3A-C, a better understanding of the invention will be served by a short explanation with reference to FIG. 1 of the essential components of a known fuel injector 1 that is identical in its construction to the embodiments with the exception of the inventive measures of the present invention.

Fuel injector 1 is designed in the form of a fuel injector for fuel injection systems of mixture compressing, externally ignited internal combustion engines. Fuel injector 1 is particularly suited for direct injection of fuel into a combustion chamber (not shown) of an internal combustion engine.

Fuel injector 1 is made up of a nozzle body 2 in which a valve needle 3 is guided. Valve needle 3 is mechanically linked with valve closing body 4, which cooperates with valve seat surface 6 arranged on valve seat body 5 to form a sealing seat. In the embodiment, fuel injector 1 is an inwardly opening fuel injector 1, having an injection orifice 7. Nozzle body 2 is sealed off from external pole 9 of magnet coil 10 by seal 8. Magnet coil 10 is contained in coil housing 11 and wound around insulating frame 12, which is in contact with an internal pole 13 of magnet coil 10. Internal pole 13 and external pole 9 are isolated from one another magnetically and are supported on connecting component 29. Magnet coil 10 is excited by an electrical current which may be supplied via line 19 via electrical contact plug 17. Contact plug 17 is enclosed by plastic mantle 18, which may be sprayed on internal pole 13.

Valve needle 3 is seated in valve needle guide 14, which is disk-shaped. Matched adjusting disk 15 is used for lift adjustment. On the other side of adjusting disk 15 is an armature 20. This is connected non-positively with valve needle 3 via first flange 21, valve needle 3 being connected to first flange 21 by welded seam 22. A first flange 21 supports a restoring spring 23, which in this design of fuel injector 1 is pre-tensioned by bush 24.

A second flange 31, which is connected to valve needle 3 via a welded seam 33, is used as the bottom armature stop. An elastic intermediate ring 32, which rests on top of second flange 31, prevents rebounding when fuel injector 1 closes.

Fuel channels 30a to 30c are arranged in valve needle guide 14, in armature 20, and on valve seat body 5. These channels supply the fuel, which is fed via central fuel supply 16 and filtered through filter element 25, to injection orifice 7. Fuel injector 1 is sealed off from a fuel line (not shown) by seal 28.

In the rest position of fuel injector 1, armature 20 is forced against its lift direction by restoring spring 23, such that valve closing body 4 is held in a sealing position in valve seat 6. When magnet coil 10 is excited, it creates a magnetic field that moves armature 20 against the spring force of restoring spring 23 in the direction of the lift, the lift being predetermined by working gap 27 which is located between internal pole 13 and armature 20 in the rest position. Armature 20 also moves flange 21, which is welded to valve needle 3, in the direction of the lift. Valve closing body 4, which is mechanically linked to valve needle 3, lifts off from valve seat surface 6 and the fuel that is fed through fuel channels 30a to 30c to injection orifice 7 is injected.

After the coil current is switched off, armature 20 drops away from internal pole 13 under the pressure of restoring spring 23 when the magnetic field has been sufficiently reduced, so that flange 21 which is mechanically linked to valve needle 3 moves against the direction of the lift. Valve needle 3 is thereby moved in the same direction, so that valve closing body 4 comes to rest on valve seat surface 6 and fuel injector 1 is closed.

FIG. 2 shows in a partial cutaway section a first embodiment of a fuel injector 1 according to the present invention. The section described is indicated in FIG. 1 by II.

FIG. 2 shows the area surrounding armature 20, which is supported on second flange 31, shown in simplified form, when fuel injector 1 is in the rest position. Second flange 31 is mechanically linked to valve needle 3 via welded seam 33. First flange 21, which supports restoring spring 23, is located on the supply side of armature 20. First flange 21 is also mechanically linked to valve needle 3 via a welded seam 22.

To provide the restriction of the fuel flow around armature 20 according to the present invention, a small stepped prominence 35 is formed on an inlet-side armature surface 34. Prominence 35 runs in the shape of a ring on inlet-side armature surface 34. In this way, the fuel flow about armature 20 is restricted. The degree to which the restriction takes effect depends among other things on surface 46 enclosed by prominence 35. The choking effect at choke point on prominence 35 enhances the existing restriction effect that is caused by lateral choke gap 26 at the external lateral surface of the mantle of armature 20.

The restriction of fuel flow results in a small buildup of dynamic pressure on armature 20. As a consequence of this dynamic pressure, armature 20 is able to disengage from internal pole 13 more quickly when the coil current exciting magnet coil 10 is switched off. This is enhanced by the reduction of the armature stop surface, which is limited to prominence 35. The adhesive forces between armature 20 and internal pole 13 are thus reduced. Together, these two effects result in a shorter valve closing time. In turn, this may be used to reduce the dimensions of restoring spring 23. This again results in improved opening behavior of fuel injector 1, since the magnetic force that acts against the force of restoring spring 23 may more easily draw armature 20 towards internal pole 13.

The height of prominence 35 is exaggerated in FIG. 2. Prominence 35 has a rectangular or slightly wedge-shaped profile, in order to prevent hydraulic adhesion of armature 20 to internal pole 13. The effects described may be achieved with a prominence 35 of no more than a few μm above the otherwise flat inlet-side armature surface 34. Various manufacturing processes are conceivable for prominence 35, such as vacuum deposition of a layer of metal or countersinking a depression in inlet-side armature surface 34.

The operation of fuel injector 1 having a choke point 36 of such kind is subject to relatively strong fluctuations. The choking effect is strongly influenced by geometric, hydraulic and thermal parameters, since, for example, the viscosity, and therewith the flow rate of the fuel, are both affected by the temperature. Accordingly, the system may exhibit a variety of operating states. For example, if the hydraulic damping is so strong that armature 20 does not strike internal pole 13, operation is ballistic. From the point of view of the dynamics, this is a desirable operating state, but it is difficult to control. If armature 20 strikes internal pole 13 in a delayed manner, the opening time of fuel injector 1 is extended.

In order to minimize the interference parameters, the system may be specifically dechoked. The choking effect is reduced particularly by boreholes in armature 20, thereby reducing the hydraulic closing force. If dechoking is carried out adequately, the operation of the system becomes non-ballistic.

FIG. 3A shows a schematic partial section of second embodiment of fuel injector 1 according to the present invention. In this case, prominence 35 is not attached to inlet-side armature surface 34, but to an outlet-side armature stop surface 37 of internal pole 13. As long as the distance between choke point 36 and valve needle 3 or the area 46 enclosed by prominence 35 remains the same, the effect of the dynamic pressure is also unchanged.

A borehole 38 is provided in armature 20 for targeted reduction of the choking effect. Borehole 38 is located within the area enclosed by annular prominence 35, so that the choking effect resulting from the smaller quantity of fuel flowing through choke point 36 is reduced. In this way, interference factors are minimized, but at the same time, it is still possible to utilize the hydraulic force on inlet-side armature surface 34.

In a view similar to FIG. 3A, FIG. 3B shows a third and fourth embodiment for targeted dechoking of the system.

Thus, the dechoking measure that in the previous embodiment took the form of borehole 38 may also be implemented as a groove-like widening of a center cutaway 39 of armature 20, as shown in the area to the left of valve needle 3 in FIG. 3B. This embodiment particularly has the advantage that the dechoking groove may be produced without major effort using center cutaway 39 of armature 20, without the need to provide additional boreholes 38 in armature 20.

The fourth embodiment, shown on the right in FIG. 3B, also has the form of a groove-like cutaway 40 in valve needle 3. This embodiment is also notable for the ease with which it may be manufactured, for example cutaway 40 may be provided in valve needle 3 by turning or milling, particularly with hydrodynamically favorable rounded edges 44.

FIG. 3C shows a schematic partial section of a fifth and sixth embodiment of fuel injector 1 according to the present invention, each having a “stop dechoking” device.

In the embodiment shown on the left in FIG. 3C, armature 20 is configured so that a recess 41, e.g. in the form of a radially extending groove, is provided on inlet-side armature surface 34, and the groove is closed by a marginally projecting prominence 42, which extends annularly along an outer edge 45 of inlet-side armature surface 34. The choking effect of choke point 36 that is created between marginally projecting prominence 42 and a shoulder 43 of internal pole 13 corresponding thereto is lessened by an amount dependent on the length of recess 41. Here too, an edge 47 facing recess 41 is chamfered or rounded to favor the flow.

In this way, particularly the length of choke gap 36 at armature stop 42, 43 is reduced without significant reduction to surface 46, which influences the dynamic pressure. During operation, this arrangement tends to remain in the ballistic area.

A sixth embodiment of fuel injector 1 according to the present invention is shown on the right in FIG. 3C. This is also furnished with a stop dechoking device.

In principle, this embodiment is similar to that described in FIG. 3A, except that borehole 38 is not located inside annular prominence 35, but is rather moved radially toward the outer perimeter of armature 20. This again further reduces the length of choke gap 36.

The invention is not limited to the embodiments shown, and may also be implemented in a wide range of designs of fuel injectors.

What is claimed is:

1. A fuel injector (1) for fuel injection systems in internal combustion engines having a magnet coil (10), an armature (20) which is acted upon in a closing direction by a restoring spring (23), and a valve needle (3) that is non-positively engaged with armature (20) for actuating a valve closing body (4), which together with a valve seat surface (6) forms a sealing seat, armature (20) striking an internal pole (13) with its inlet-side armature surface (34),
wherein a choke point (36) is provided on inlet-side armature surface (34), which is formed by an annular, stepped prominence (35) on the inlet-side armature surface (34) and/or an outlet-side armature stop surface (37) of the internal pole (13).

2. The fuel injector according to claim 1,
wherein means for dechoking (38, 39, 40, 41) are provided on the armature (20) close to the choke point (36).

3. The fuel injector according to claim 1 or 2,
wherein the prominence (35) has a rectangular or wedge-like shape.

4. The fuel injector according to any of claims 1 to 3,
wherein the choking effect of the choke point (36) is reduced by a borehole (38) in the armature (20).

5. The fuel injector according to claim 4,
wherein the borehole (38) is applied within an area (46) enclosed by the prominence (35).

6. The fuel injector according to any of claims 1 to 4,
wherein the choking effect of the choke point (36) is reduced by a center cutaway (39) in the armature (20).

7. The fuel injector according to any of claims 1 to 4,
wherein the choking effect of the choke point (36) is reduced by a cutaway (40) in the valve needle (3).

8. The fuel injector according to either of claims 6 or 7,
wherein the cutaways (39, 40) in the armature (20) and on the valve needle (3) have a groove-like design.

9. The fuel injector according to either of claims 7 or 8,
wherein the cutaway (40) in the valve needle (3) has rounded or chamfered edges (44).

10. The fuel injector according to claim 4,
wherein the borehole (38) is located outside the area (46) enclosed by the prominence (35).

11. The fuel injector according to any of claims 1 to 10,
wherein a shoulder (43) is formed on the outlet-side armature stop surface (37) of the internal pole (13).

12. The fuel injector according to claim 11,
wherein the armature (20) is provided with a recess (41) on the inlet-side armature surface (34).

13. The fuel injector according to claim 12,
wherein the recess (41) is enclosed by a prominence (42) around the rim.

14. The fuel injector according to claim 13,
wherein the prominence (42) around the rim has a rounded edge (47) facing the recess (41).

15. The fuel injector according to claim 14,
wherein the choke point (36) is formed between the prominence (42) around the rim and the shoulder (43).
